(19) United States
(12) Patent Application Publication
(10) Pub. No.: US 2023/0398804 A1
(43) Pub. Date: Dec. 14, 2023

(54) GREETING CARD WITH FIREWORKS EFFECT

(71) Applicant: JAST Gifts Shenzhen Company Limited, Shenzhen City (CN)

(72) Inventor: Jen-Lin CHEN, Cupertino, CA (US)

(73) Assignee: JAST Gifts Shenzhen Company Limited, Shenzhen City (CN)

(21) Appl. No.: 17/839,563

(22) Filed: Jun. 14, 2022

(51) Int. Cl. B42D 15/02; B42D 15/04; G09F 1/06

(52) U.S. Cl. CPC B42D 15/022; G09F 1/06; B42D 15/042

(57) ABSTRACT

The invention relates to a foldable greeting card having an outer side and an inner side and a number of electronic and electrical components, the card (1) being provided in a foldable manner, comprising a fold at one point which divides the card preferably into two parts (2, 3) of equal size, thus having two halves which can be folded congruently on top of one another, at least one part (2) being provided at least partially in two layers with an inner and an outer layer, and at least some of the electronic and electrical components comprising light and acoustic elements (5, 9) for generating light and sound effects, a switch (8) for activating the light and acoustic elements (5, 9), a circuit or microprocessor (7) for controlling the electrical components, and a power supply (10) being provided between the inner and outer layers of the card (1), and wherein the inner side of the two-layered part (2) comprises cut-outs (4) through which various light effects of the light elements (5) can shine through and wherein the light effects and sound effects are synchronized with each other to simulate fireworks.

### FIELD AND BACKGROUND OF THE INVENTION

The invention relates to a greeting card with light and sound effects and in particular to a greeting card with simulated fireworks effects.

Greeting cards have been known for a long time in various designs. Also known are greeting cards that are folded and create various light and sound effects when unfolded.

Furthermore, 3D greeting cards are known, which comprise a usually simply folded card as a base with a figure arranged in this card. The essential function of such a 3D greeting card is that an initially essentially two-dimensional folded figure rises three-dimensionally from the card plane when the folded card is opened or unfolded.

Preferably, such greeting cards can be opened from a closed or folded state by unfolding the card by a total of 90 to 180 degrees.

The underlying mechanism is based on the fact that the compressed figure is secured in the card in such a way that, by opening the folded card, a tensile stress is applied to the figure which transfers the figure from the compressed to the three-dimensional or expanded shape.

The object of the present invention is to provide a greeting card which, when unfolded, provides a convincing simulation of a fireworks display with light and sound effects.

### SUMMARY OF THE INVENTION

s This object is solved by an invention having the features of claim 1. Advantageous embodiments are respectively the subject of the dependent claims. It should be noted that the features listed individually in the claims can also be combined with one another in any desired and technologically useful manner, thus showing further embodiments of the invention.

The foldable greeting card according to the invention has an outer side and an inner side, the card being provided foldable, i.e. having a fold at one point which divides the card preferably into two parts of equal size, i.e. two halves which can be folded congruently on top of each other, at least one of these parts being provided at least partially in two layers with an inner and an outer layer.

It is further preferred that at least one part, namely one of the halves of the card, is provided in two layers as a whole. A two-layer design of the card is advantageous in order to be able to arrange the electronics or electrics, hereinafter referred to as electronics for the sake of simplicity, which are to be described in more detail below, in a sandwich-like manner between the two layers and thus conceal them. If the dimensions of the electronics make it necessary, the two-layer arrangement can also be expanded to box-shaped, i.e. with a larger internal volume.

The light and sound elements, preferably LEDs as light elements and loudspeakers as sound elements, are activated or controlled via electronic or electrical elements, hereinafter referred to as electronic elements for the sake of simplicity, such as a power supply, a switch and an integrated circuit. Where necessary, the electronic elements are interconnected by wires or other contacts and may be arranged at least partially together on a printed circuit board.

Preferred lighting elements are LEDs as described, although colours and number of LEDs can be arbitrary. Preferred sound elements are loudspeakers. The light and sound elements are provided to output certain optical and acoustic effects and stimuli, respectively, the optical and acoustic effects being synchronized with each other to produce a realistic effect, especially in the case of fireworks simulations. A preferred power supply is batteries or rechargeable batteries.

The switch is used to activate the electronics when the greeting card is opened, in order to complement the opening and/or the opened state of the greeting card with visual and acoustic effects. Accordingly, all types of switches including light or motion sensors are suitable for activating the electronics by opening the card. Corresponding switches and sensors are known to the skilled person.

Preferably, the part of the greeting card that depicts the fireworks effects is provided in two layers, although embodiments are conceivable in which all parts of the card include respective effects and thus all parts can be provided in two layers.

The part of the greeting card depicting the fireworks effects, which is usually at least part of the inside of the greeting card, comprises—in addition to a possible graphic depiction of a firework or other elements such as a landscape or a city skyline—in particular cut or punched or otherwise produced cut-outs through which the light effects produced by the light elements can penetrate. The cut-outs may additionally be provided with various at least semipermeable materials, such as paper or foil, for example, in order to create additional optical effects and stimuli.

In a further embodiment, the greeting card optionally comprises at least one foldable element reversibly convertible from a flat compressed state to a three-dimensional expanded state, wherein the foldable element is fixed to the inner surface of the foldable card.

The at least one foldable element can be reversibly transformed from a folded or compressed state to an unfolded or expanded state and vice versa. The transformation is triggered by opening or closing the foldable card.

The card shall be considered opened when the two parts of the card have been unfolded altogether by an angle of at least 90°. On the other hand, the card is to be regarded as closed when the two parts or halves of the card lie on top of each other and their inner sides lie on top of each other.

### BRIEF DESCRIPTION OF THE SEVERAL VIEWS OF THE DRAWINGS

The invention and the technical environment are explained in more detail below with reference to the figures. It should be noted that the figures show a particularly preferred embodiment of the invention. However, the invention is not limited to the embodiment variant shown. In particular, the invention includes, to the extent that it is technically useful, any combination of the technical features listed in the claims or described in the description as relevant to the invention.

Showing:

FIG. 1 a greeting card according to the invention in the closed state;

FIG. 2 the greeting card in the opened state;

FIG. 3 the greeting card in the opened state with indicated inside arrangement of the electronics;

FIG. 4 the greeting card in the opened state with further decorative elements in the front view A and the side view B.

### DESCRIPTION OF SPECIFIC EMBODIMENTS OF THE INVENTION

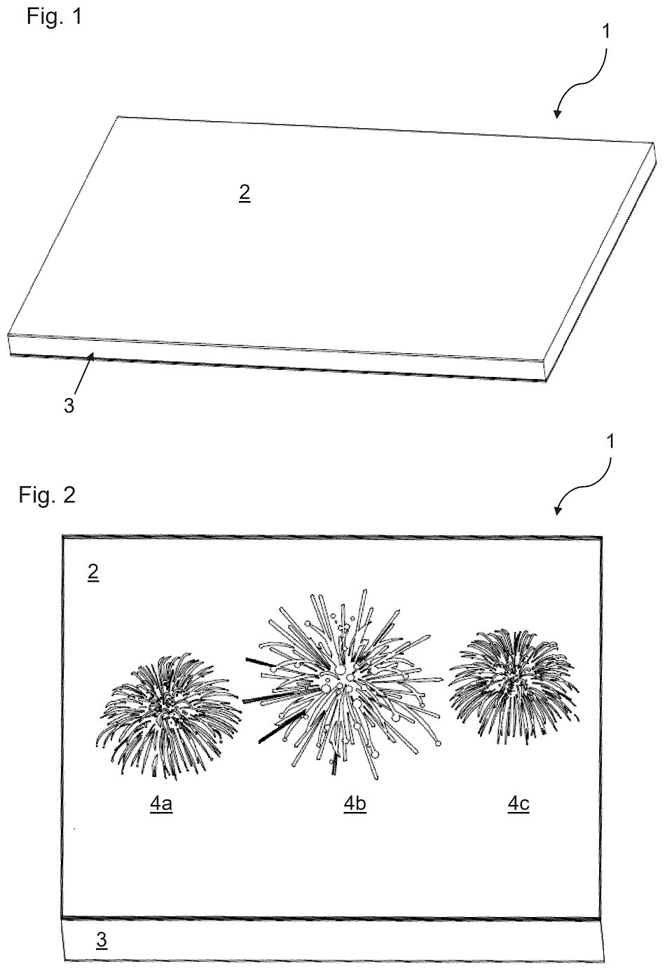

FIG. 1 shows the greeting card 1 according to the invention in the closed or folded or collapsed state, the two parts 2, 3 of the greeting card 1 lying substantially congruently on top of one another. Embodiments are conceivable in which the card 1 is also divided into more than two parts 2, 3 and the parts 2, 3 do not lie congruently on one another.

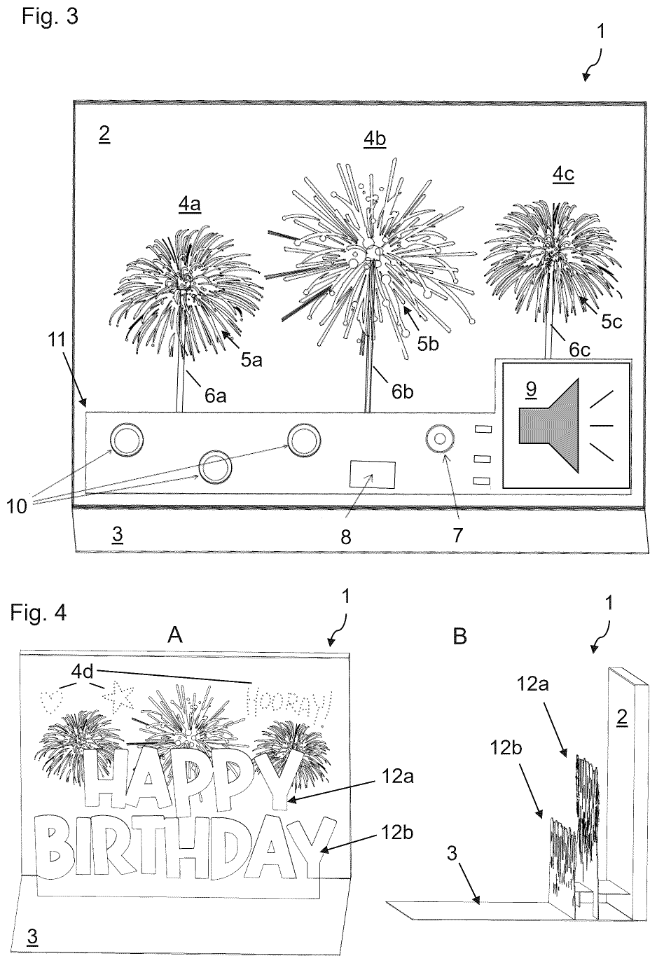

FIG. 2 shows the greeting card 1 according to the invention in the opened or unfolded state, the two parts 2, 3 of the greeting card 1 forming a substantially perpendicular angle to one another. On the inside of one part 2 of the greeting card 1, various graphic elements 4 are provided, which have cut-outs through which various light effects can shine through, which are produced by light elements (shown in FIG. 3) located underneath or behind them, such as LEDs. At least semi-transparent materials like for example films or papers can be provided in the cut-outs for further effects.

FIG. 3 shows the greeting card 1 according to the invention in the opened state, whereby here the arrangement of the substantial electrical as well as electronic components in the opened part 2 of the greeting card 1 is depicted schematically. These components are provided in the two-layered part 2 of the greeting card 1 between the first and the second layer.

In particular, behind the graphic elements 4, the lighting elements 5, generally LEDs, are provided, which are connected to the other electronic elements, if necessary, via connecting elements 6. The other electronic elements, in particular the circuit or microprocessor 7 for controlling the light and sound elements 5, 9, the switch 8 for activating the light and sound elements 5, 9 when the card is opened, the loudspeaker 9 and the batteries 10 for supplying power to the electronic components may be arranged on a printed circuit board 11.

FIG. 4 shows the greeting card 1 according to the invention in a further development with additional 3D elements 12, which are arranged on the inside of the greeting card 1 and change from their flat position (not shown) to the upright or three dimensional position when the greeting card 1 is opened, thus adding a further effect to the greeting card 1. Such further 3D elements can add much more depth to the card and thus increase the visual effect, especially in the case of the “fireworks” theme.

### LIST OF REFERENCE SIGNS

1 Greeting card
2 First half/part of the greeting card
3 Second half/part of the greeting card
4 Graphic elements of the greeting card with cut-outs (a to d)
5 LEDs
6 Connecting elements/wires
7 Integrated circuit (IC), microprocessor
8 Switch
9 Loudspeaker
Batteries
11 Printed circuit board (PCB)
12 3D elements

What is claimed is:

1. Foldable greeting card having an outer side and an inner side and a number of electronic and electrical components, the card (1) being provided in a foldable manner, comprising a fold at one point which divides the card (1) preferably into two parts (2, 3) of equal size, thus having two halves which can be folded congruently on top of one another, at least one part (2) being provided at least partially in two layers with an inner and an outer layer, and at least some of the electronic and electrical components comprising light and acoustic elements (5, 9) for generating light and sound effects, a switch (8) for activating the light and acoustic elements (5, 9), a circuit or microprocessor (7) for controlling the electrical components, and a power supply (10) being provided between the inner and outer layers of the card (1), and wherein the inner side of the two-layered part (2) comprises cut-outs (4) through which various light effects of the light elements (5) can shine through and wherein the light effects and sound effects are synchronized with each other to simulate fireworks.

2. Foldable greeting card according to claim 1, characterized in that the light elements (5) are LEDs.

3. Foldable greeting card according to claim 1, characterized in that the greeting card (1) comprises at least one foldable element (12) reversibly transferable from a flat compressed state to a three-dimensional expanded state, the foldable element (12) being fixed to the inner side of the foldable card (1).

4. Foldable greeting card according to claim 1, characterized in that the electrical as well as electronic elements, in particular the circuit or microprocessor (7), the switch (8), the acoustic elements (9) and the batteries (10) for power supply are arranged on a printed circuit board (11).

5. Foldable greeting card according to claim 1, characterized in that the cut-outs (4) are provided with different at least semipermeable materials.
